(19) United States
(12) Patent Application Publication
(10) Pub. No.: US 2005/0111306 A1
(43) Pub. Date: May 26, 2005

(54) Portable wrist-worn personal electronic device

(75) Inventors: Jarmo Saaski, Kempele (FI); Tero Mattinen, Kempele (FI)

Correspondence Address: HOFFMANN & BARON, LLP, 6900 JERICHO TURNPIKE, SYOSSET, NY, 11791, US

(73) Assignee: Polar Electro OY

(21) Appl. No.: 10/809,043

(22) Filed: Mar. 25, 2004

(30) Foreign Application Priority Data
Nov. 20, 2003 (FI) 20031689

(51) Int. Cl. G04B 37/00

(52) U.S. Cl. 368/282

(57) ABSTRACT

The invention relates to a wrist-worn electronic device comprising a case, a wristband structure and attachment arrangements for attaching the case to the wristband structure. Each attachment structure comprises a positioning structure and a locking structure. In the invention the positioning structure comprises positioning means (21, 31) locating in the case wall and extending in the direction between the front surface (6) of the case and the reverse surface (7) of the case. The positioning structure comprises, in the wristband structure, on the reverse side thereof, positioning counterparts (22, 32). The locking structure comprises, on the reverse side of the wristband, a locking projection structure (61, 62) that is an integral part of the wristband and as a counterpart of said locking projection structure the case (4) comprises a locking counterpart (60, 60a) for preventing the wristband from becoming apart from the case.

### FIELD

The invention relates to a portable, wrist-worn, personal electronic device comprising:
a case including a component space, the case comprising a front side and, on the opposite side of the case, a reverse side,
a wristband structure for wrist attachment of the case, there being two attachment points between the case and the wristband structure on the different edges of the case, the wristband structure comprising a front side and, on the opposite side of the wristband structure, a reverse side,
an attachment arrangement at both attachment points for attaching the case and the wristband structure to one another, each attachment arrangement comprising a positioning structure for mutual positioning of the case and the wristband structure and a locking structure for interlocking the case and the wristband structure.

### BACKGROUND

In portable, wrist-worn electronic devices, such as watches and heart rate monitors, the most conventional prior art attachment arrangement between a device case and a wristband consists of attaching a wristband part to an edge of the case with a specific push-pin. Known solutions that employ push-pins are not convenient for the user, because it is a difficult and cumbersome operation for an average user to take the pin out, for instance, for a wristband change. A further problem is that the push-pin only locks the wristband with the case, but it does not support, i.e. provide mutual positioning of the wristband and the case.

From U.S. Patent Application 2003/0002394 there is known a portable electronic wrist-worn device, in which a positioning structure consisting of projections, provided at the end of the wristband and transverse to the wristband plane, and recesses in the case extends in parallel with the case surfaces. Hence, the wristband must be mounted in the direction of the case plane from the case end, and the basic structure of the positioning structure is such that it occupies space in the longitudinal direction of the case and the wristband, In addition, it is to be noted that the wristband is perpendicular to the case of the device, which has a result that the position of the wristband will not be comfortable unless the longitudinal measurement of the case matches the width of the user's wrist. Another problem with said solution is that the locking part between the wristband and the case is a loose locking staple, and it requires precision to attach and detach it and carefulness to keep it safe when loose. The locking staple is put in place from the back, and it poses a problem that the device must be turned upside down for every operation relating to the staple.

### BRIEF DESCRIPTION

The object of the invention is to implement a portable, wristworn personal electronic device so as to achieve a device that is better and more widely applicable than previous devices. This is achieved by a device that is characterized in that for enabling attachment of a wristband to a case from the front side of the case with the reverse side of the wristband structure ahead, each attachment arrangement has a positioning structure that comprises positioning means locating in the case wall and extending in the direction between the front and back surfaces of the case, and as counterparts of these positioning means belonging to the case the positioning structure comprises positioning counterparts on the reverse side of the wristband structure, the direction of which positioning counterparts corresponds that of the positioning means belonging to the case structure, and that in each attachment arrangement the locking structure comprises, on the reverse side of the wristband, a locking projection structure that is an integral part of the wristband, and as a counterpart of the locking projection structure the case comprises a locking counterpart to prevent the wristband from becoming apart from the case.

The preferred embodiments of the invention are disclosed in the dependent claims.

The invention is based on the idea that the direction of the positioning means comprised by the case and the wristband are implemented such that they enable the wristband to be attached to the case from above, and in addition, the invention is based on the idea that locking is implemented without any loose locking parts while the wristband is being positioned to engage with the case.

Several advantages are achieved with the device of the invention. The device of the invention provides a possibility to achieve good positioning and locking for the wristband, enabling, however fast, easy and reliable detachment or replacement of the wristband without loose and thus easily lost locking parts.

### LIST OF FIGURES

In the following, the invention will be described in greater detail in connection with preferred embodiments, with reference to the attached drawings, wherein

FIG. 1 shows a top view of a device case and detached wristband parts of a wristband structure to be attached on the opposite edges of the case;

FIG. 2 shows a top view of the parts of FIG. 1 attached to one another;

FIG. 3 shows an end of the case in the longitudinal direction of the device, seen from the wristband direction;

FIG. 4 shows an end of the wristband part in the longitudinal direction of the device, seen from the case direction;

FIG. 5 shows a detail of a locking structure between the wristband structure and the case.

The question is about a portable, personal electronic device 3 to be fitted round the user's wrist. For example, the device can be a heart rate monitor, a health watch, a sports watch, a weight control device, a compass, a wrist watch or some other device.

The device 3 comprises a case 4 that comprises a component space 5. The component space is intended for components necessary for the operation of the device. A wall of the case 5 delimits the component space. The device has a front side 6, i.e. a top side, and, on the opposite side of the case, a reverse side 7, which is against the user's wrist. The figures do not show a protective glass/crystal arranged on the front surface 6 of the case and closing the component space from the top, nor a back cover arranged on the reverse side surface of the case and closing the component space from the reverse side.

In the case of a heart rate monitor, the component space 5 would hold a measuring sensor or a reception coil receiving a signal from a chest-worn electrode belt, and the component space would further hold electronic elements for signal processing, such as a filter and an amplifier, and the component space would also hold a microprocessor and a user interface, which user interface would comprise a display and one or more switch buttons.

In addition, the device 3 comprises a wristband structure 8-9 for fitting the case 4 on the wrist. The wristband structure has a front side 10 and, on the opposite side of the wristband structure, a reverse side 11. In the examples of the figures the wristband structure comprises two separate parts 8 and 9, which are interconnected with a clasp or any other connector, but the wristband may also be a one-piece structure, in particular, if the wristband structure is elastic.

The device 3 also comprises an attachment arrangement for interconnecting the case 4 and the wristband structure 8, 9. The description hereinbelow deals mainly with the attachment arrangement between the wristband part 8 and the case 4, because the attachment arrangement between the second wristband part 9 of the wristband structure and the case 4 is of the same type as the attachment arrangement between the wristband part 8 and the case 4.

The attachment arrangement comprises a positioning structure 21, 22, 31, 32 for mutual positioning of the case 4 and the wristband part 8 and a locking structure 60-62 for interlocking the case 4 and the wristband structure 8. The positioning structure and the locking structure are implemented in a manner that enables the attachment of the wristband structure to the case from the case front 6 with the reverse side of the wristband structure ahead.

Thus, the positioning structure comprised by the attachment arrangement comprises positioning means 21, 31 belonging to the case and extending in the direction between the front side and the reverse side of the case, and as counterparts to these positioning means, in the wristband structure on the reverse side of the wristband structure, the positioning structure comprises positioning counterparts 22, 32, the direction of which corresponds to that of the positioning means 21, 31 of the case structure 4. The positioning means 21, 31 of the case structure extending in the direction between the front side 6 and the reverse side 7 of the case are recesses delimited by a case wall and the positioning counterparts 22, 32 are projections whose surfaces are in contact with the surfaces of the recess-like positioning means 21, 31. It is an advantageous embodiment that the projections 22, 32 belong to the wristband structure and the recesses 21, 31 belong to the case structure 4, because the structure that is more vulnerable, i.e. the projections 22, 32, is located in the part whose manufacturing costs are lower, i.e. in the wristband structure.

The locking structure comprised by the attachment arrangement, in turn, comprises, on the reverse side of the wristband 8, a locking projection structure 61-62 that is an integral part of the wristband 8, and as a counterpart to said locking projection structure the case 4 comprises a locking counterpart 60 to prevent the wristband from becoming apart from the case.

There are at least two pairs consisting of positioning means, such as 21, 31, in the wall of the case 4 and positioning counterparts, such as 22, 32, comprised by the wristband structure at each mutual attachment zone of the wristband structure and the case, i.e. two pairs between the wristband structure 8 and the case 4 and two pairs between the wristband structure 9 and the case 4. The pairs of positioning means/positioning counterpart are located on different sides of the longitudinal median line of the device, which allows good positioning, i.e. support.

In a preferred embodiment the positioning structure comprises several, for example four as in the figures, pairs of positioning means/positioning counterparts, i.e. the pairs 21-22, 31-32, 41-42 and 51-52. The positioning counterparts 22, 32, 42 and 52 are stud-like projections on the reverse side of the wristband 8 and the positioning means 21, 31, 41 and 51 are recesses in the wall of the case 4, in which the stud-like positioning counterparts 22, 32, 42 and 52 will be seated. With said structure it is possible to achieve improved support between the case 4 and the wristband 8. In the example of the figures there are four pairs of positioning means/positioning counterparts, the outermost of which, i.e. the pairs 21-22 and 31-32 are mutually of the same type, in other words their cross section is round, whereas the pairs of positioning means/positioning counterparts 41-52 and 51-52 around the locking structure 60-62, i.e. those locating more in the middle of the device seen in the transverse direction, are for instance triangular in shape as in the figures or otherwise shape locking, i.e. they prevent transverse rotation between the case 4 and the wristband 8 thanks to their shape.

Next, let us study the locking structure 60-62 in greater detail. In the preferred embodiment the locking projection structure 61-62 on the reverse side of the wristband 8 extends in the same direction as the positioning counterparts 22 and 32 on the reverse side of the wristband 8, which facilitates the attachment of the wristband to the case. The locking counterpart 60 of the case serving as a counterpart to the locking projection structure 61-62 of the wristband 8 comprises a space for projection 60a delimited by the wall material of the case 4, to which space the locking projection extends.

In the preferred embodiment the projection 61-62 of the locking projection structure is of stem type and it that can be pushed or pressed against stem tension such that it can be fitted into the locking counterpart 60 comprised by the case. In the example of the figures the locking projection structure comprises two adjacent projecting stems 61-62, and hence there is a need to bring the stems 61-62 closer to one another in order to be able to fit the locking projection stem structure 61-62 in the aperture 60a of the locking counterpart 60. In the preferred embodiment the tip of the locking projection structure 61-62 is designed such that the locking projection structure 61-62 has a self-guiding form 65 that enables introduction of the stems of the locking structure into the aperture 60a of the locking counterpart 60 just by pressing the wristband 8 downwardly towards the case 4. Thus no separate operation is needed, in which a person should press the stems of the locking projection structure closer to one another so as to manage to introduce the stems 61-62 into the aperture 60a of the collar-like locking counterpart 60.

For easier locking, yet with a structure that can be readily manufactured, the device is such that the locking counterpart 60 of the case 4 comprises a locking surface 67 transverse to the space for projections 60a for locking the locking projection 61-62 into place with respect to the locking means 68, such as the locking surface 68, comprised by the locking projection structure 61-62.

For easier attachment of the wristband 8 and the case 4, the device is such that the space for projections 60a, delimited by the case wall material and comprised by the locking counterpart 60 of the case 4, provided for the locking projection structure 61-62 comprised by the wristband 8 extends in the same direction as the positioning means 21, 31, 41, 51 comprised by the case.

Thus, in the preferred embodiment the device is such that the recesses comprised by the case, i.e. the positioning means 21, 31, 41, 51 and the locking projection space 60a comprised by the case extend in the direction between the front 6 and the back 7 of the device, and the projections, i.e. the positioning counterparts 22, 32, 42, 52, comprised by the wristband and the locking projection structure 61-62 comprised by the wristband also extend in the same direction. Locking is performed by the same movement as the positioning, i.e. by the same movement as the introduction of the wristband projections into the recesses in the case.

In the preferred embodiment the case 4 is a moulded piece. In the preferred embodiment the case 4 is of plastic material. The plastic material is, for instance, polyethylene-type plastic or glass-fibre reinforced plastic. The case can also be made of metal. In the preferred embodiment the wristband is also of plastic. The locking projection 61-62 comprised by the wristband structure can be of the same plastic as the wristband or the locking projection 61-62 can be an insert made of harder plastic or metal and integrated with the wristband.

The wristband 8 will be detached from the case 4 such that at the locking arrangement, on the reverse side of the device, the device has an opening at the tip of the locking device 61-62, or an opening 88 can be provided there, for instance such that at the end of the wristband, on the reverse side thereof, there is provided a covering area, as an extension to the wristband zone of normal thickness, that is sufficiently thin for bending and by bending it in the longitudinal direction of the wristband, away from the case, or by bending it otherwise, a free passage, i.e. opening, can be provided, which permits pressing the locking projections 61-62. Through said opening the locking projection stems 61-62 are pressed closer to one another, whereby the distance between the tips of the projections 61-62 will be narrower than the width of the space for projections 60a in the locking counterpart 60 of the case. Next, the wristband 8 is lifted in a direction transverse to the plane of the case 4, for instance perpendicularly thereto, whereby the stud-like positioning counterparts 22, 32, 42, 52 of the wristband 8 slide along the recesses, i.e. the positioning means 21, 31, 41, 51 of the case 4, while the pair of locking projection stems 61-62 of the wristband 8 slides in the projection space 60a of the locking counterpart 60 comprised by the case structure 4. The detaching movement being performed sufficiently high upwardly, the wristband 8 is released from the recesses of the case, i.e. the positioning means 21, 31, 41, 51 and from the locking projection space 60a of the case.

The wristband 8 is mounted to the case structure such that the wristband 8 is introduced from above, with the reverse side ahead, over the edge of the case such that the stud-like positioning counterparts 22, 32, 42, 52 on the reverse side of the wristband will be in alignment with the recesses of the case 4, i.e. the positioning means 21, 31, 41, 51, while the locking projection structure 61-62, also on the reverse side of the wristband, will be in alignment with the recess-like space for locking projections 60a of the collar of the locking counterpart 60 comprised by the case 4. The wristband 8 is then pressed downwardly, whereby the studs of the positioning counterpart 22, 32, 42, 52 slide along the recess-like positioning means 21, 31, 41, 51 of the case 4 and the stem pair 61-62 of the locking projection structure comprised by the wristband 8 proceeds along the locking projection space 60a in the collar of the locking counterpart 60 of the case 4.

The mounting movement is continued until the wristband is properly in place, i.e. until the tip portion of the locking projection structure 61-62 emerges from the bottom of the locking projection space 60a, whereby the tension in the locking projection stems 61-62 is able to widen the distance between the locking projection stems 61-62 and thus the locking means 67, such as the locking surface 67, of the case and the locking means 68, such as the locking surface 68, of the locking projection structure 61-62 interlock by means of the tension in the stem structure 61-62, whereby the wristband and the case are prevented from being released from interlocking.

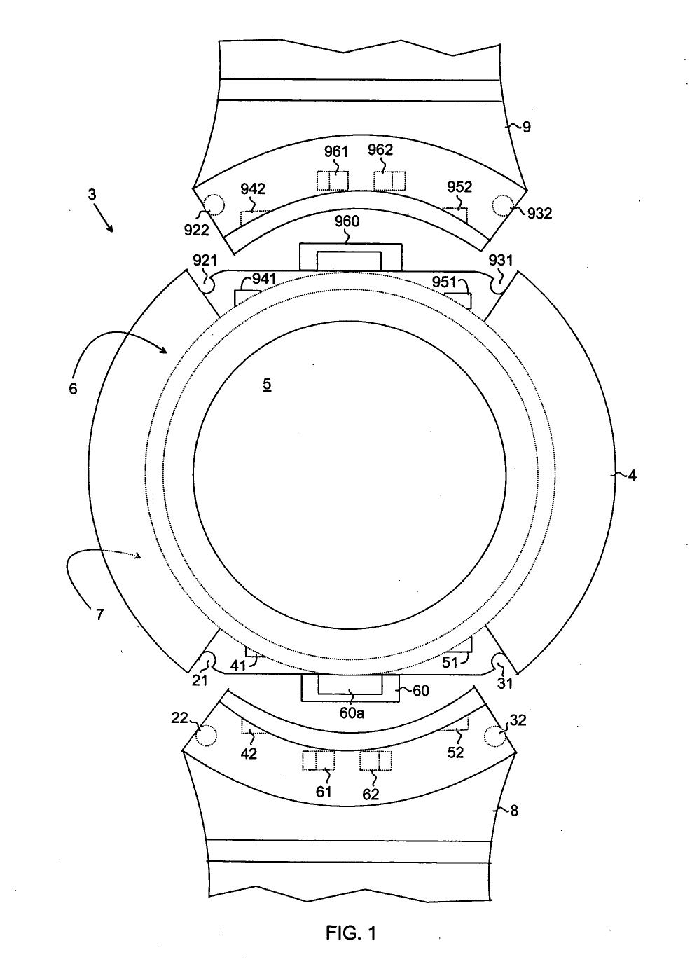

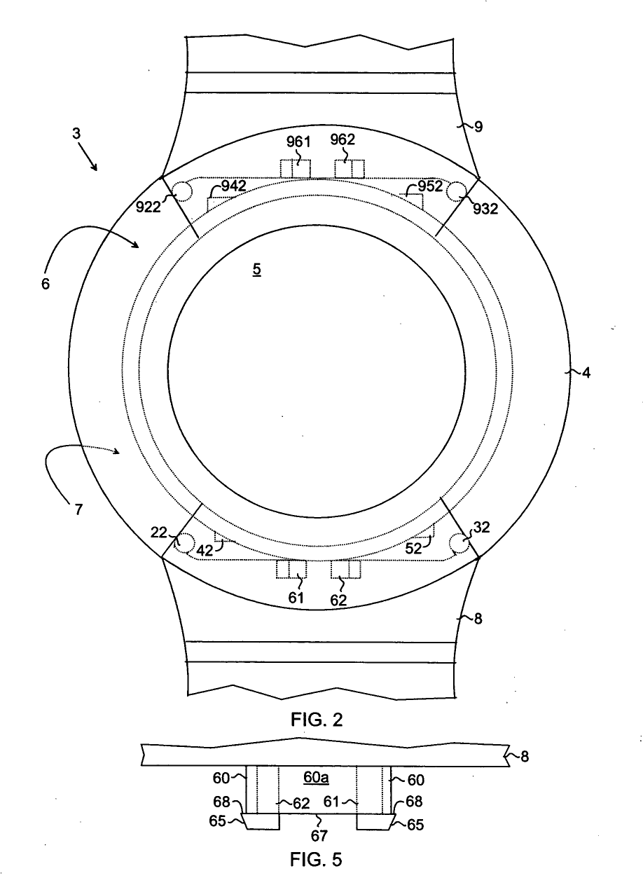

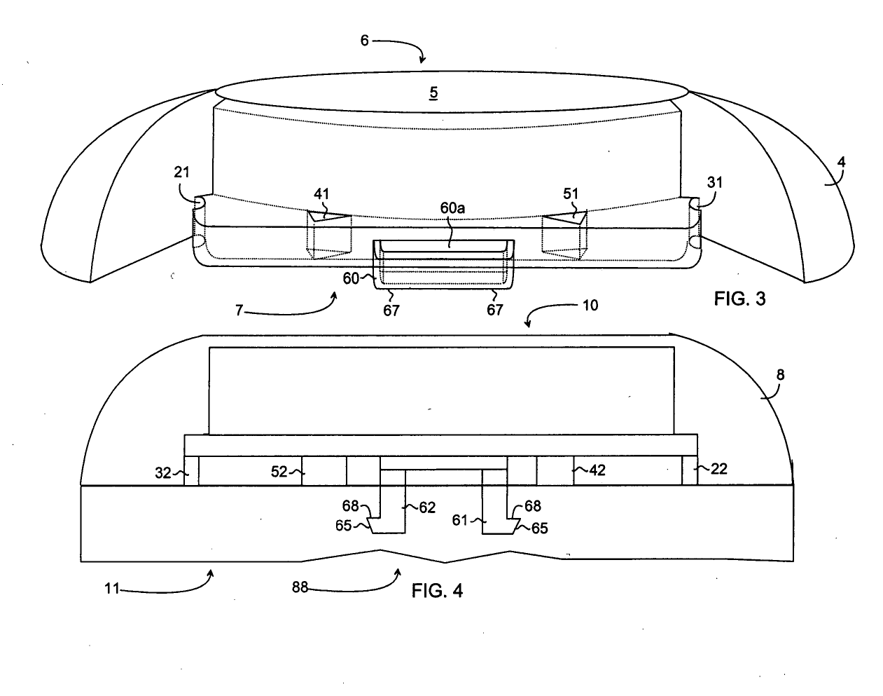

As stated above, the attachment between the second wristband part 9 comprised by the wristband structure and the case 4 is similar to the attachment between the wristband part 8 and the case 4. Mainly, with reference to FIGS. 1 to 2, it is stated that the positioning structure of said second attachment zone advantageously comprises corresponding four pairs of positioning means/positioning counterparts, i.e. pairs 921-922, 931-932, 941-942 and 951-952. The positioning counterparts 922, 932, 942 and 952 are stud-like projections on the reverse side of the wristband 9 and the positioning means 921, 931, 941 and 951 are recesses in the wall of the case 4, in which the stud-like positioning counterparts 922, 942, 952 fit. Correspondingly, the locking structure between the case 4 and the wristband part 9 comprises on the reverse side of the wristband 9 a locking projection structure 961-962 that is integral with the wristband and as a counterpart to the locking projection structure the case 4 comprises a locking counterpart 960 to prevent the wristband from coming apart from the case.

Even though the invention is described in the above with reference to the example of the accompanying drawings, it is apparent that the invention is not restricted thereto but it can be modified in a variety of ways within the scope of the attached claims.

1. A portable, wrist-worn, personal electronic device comprising:
a case including a component space, the case comprising a front side and, on the opposite side of the case, a reverse side,
a wristband structure for wrist attachment of the case, there being two attachment points between the case and the wristband structure on different edges of the case, the wristband structure comprising a front side and, on the opposite side of the wristband structure, a reverse side,
an attachment arrangement at both attachment points for attaching the case and the wristband structure to one another, each attachment arrangement comprising a positioning structure for mutual positioning of the case and the wristband structure and a locking arrangement for interlocking the case and the wristband structure, wherein
for enabling attachment of the wristband to the case from the front side of the case with the reverse side of the wristband structure ahead, each attachment arrangement has a positioning structure that comprises positioning means locating in the case wall and extending in the direction between the front side and the reverse side of the case, and as counterparts of the positioning means belonging to the case the positioning structure comprises positioning counterparts on the reverse side of the wristband structure, the direction of which positioning counterparts corresponds to that of the positioning means belonging to the case structure, and that in each attachment arrangement the locking structure comprises, on the reverse side of the wristband, a locking projection structure that is an integral part of the wristband, and as a counterpart of said locking projection structure the case comprises a locking counterpart to prevent the wristband from becoming apart from the case.

2. The device of claim 1, wherein the locking projection structure on the reverse side of the wristband structure extends in the same direction as the positioning counterparts on the reverse side of the wristband.

3. The device of claim 1, wherein the locking counterpart comprised by the case and serving as a counterpart of the locking projection structure comprised by the wristband comprises a locking projection space delimited by the case wall material, to which space the locking projection structure extends.

4. The device of claim 1, wherein the locking counterpart comprised by the case comprises a locking means that is transverse to the locking projection space for locking in place the locking projection structure fitted into the locking projection space by means of the locking means comprised by the locking projection structure.

5. The device of claim 1, wherein the locking projection structure comprised by the wristband is a strainable stem structure, which, when strained, can be fitted into the locking projection space of the locking counterpart comprised by the case.

6. The device of claim 1, wherein the locking projection space, delimited by the case wall and comprised by the locking counterpart of the case, for the locking projection structure of the wristband extends in the same direction as the positioning means of the case.

7. The device of claim 1, wherein the positioning means belonging to the case structure and extending in the direction between the front and the reverse of the case are recess-like spaces delimited by the case wall.

8. The device of claim 1, wherein the positioning counterparts comprised by the wristband structure are stud-like parts.

9. The device of claim 1, wherein there are at least two pairs of positioning means comprised by the case and positioning counterparts of the wristband at each mutual attachment point of the wristband structure and the case, and that these pairs of positioning means/positioning counterparts are on different sides of the longitudinal median line of the device.

10. The device of claim 2, wherein the locking counterpart comprised by the case and serving as a counterpart of the locking projection structure comprised by the wristband comprises a locking projection space delimited by the case wall material, to which space the locking projection structure extends.
